(19) United States
(12) Patent Application Publication
(10) Pub. No.: US 2020/0012450 A1
(43) Pub. Date: Jan. 9, 2020

(54) STORAGE SYSTEM, STORAGE CONTROL METHOD AND STORAGE CONTROL DEVICE

(71) Applicant: FUJITSU LIMITED, Kawasaki-shi (JP)

(72) Inventors: Masaki Takeuchi, Kawasaki (JP); Yoshimasa MISHUKU, Yokohama (JP); Yutaro Hiraoka, Kawasaki (JP)

(73) Assignee: FUJITSU LIMITED, Kawasaki-shi (JP)

(21) Appl. No.: 16/442,661

(22) Filed: Jun. 17, 2019

(30) Foreign Application Priority Data
Jul. 4, 2018 (JP) 2018-127599

(51) Int. Cl. G06F 3/06; H04L 29/08

(52) U.S. Cl. CPC G06F 3/0658; G06F 3/0604; G06F 3/067; H04L 67/1097

(57) ABSTRACT

A storage system includes a plurality of server nodes including a first server node and a second server node paired with the first server node, and a manager node configured to manage the plurality of server nodes, wherein the first server node is configured to transmit a notification to the manager node in response to detecting that the second server node is down, and the notification indicates that the second server node is down, and wherein the manager node is configured to execute a first process related to a second process executed by the second server node in response to receiving the notification.

### CROSS-REFERENCE TO RELATED APPLICATION

This application is based upon and claims the benefit of priority of the prior Japanese Patent Application No. 2018-127599, filed on Jul. 4, 2018, the entire contents of which are incorporated herein by reference.

### FIELD

The embodiments discussed herein are related to a storage control technique.

### BACKGROUND

In recent years, a software defined storage (SDS) system including a plurality of computer nodes (hereinafter, simply referred to as nodes) has been known.

FIG. 13 is a diagram schematically illustrating a configuration of a SDS system 500 of the related art. In the SDS system 500, a plurality of nodes 501-1 to 501-3 (three in the example in FIG. 13) are mutually connected via a network 503. Storage devices 502 which are respectively physical devices are connected to the nodes 501-1 to 501-3.

Among the plurality of nodes 501-1 to 501-3, the node 501-1 functions as a manager node that manages the other nodes 501-2 and 501-3. The nodes 501-2 and 501-3 function as agent nodes that perform a process in accordance with control of the manager node 501-1. Hereinafter, the manager node 501-1 may be indicated by Mgr #1. The agent node 501-2 is indicated by Agt #2 and the agent node 501-3 is indicated by Agt #3.

Hereinafter, as a symbol indicating the agent node, when it is preferable to specify one of the plurality of agent nodes, symbols 501-2 and 501-3 are used, but when any agent node is referred to, symbol 501 is used.

A request from a user is input into the manager node 501-1 and the manager node 501-1 creates a plurality of processes (commands) to be executed by the agent nodes 501-2 and 501-3 to realize the request of the user.

FIG. 14 is a diagram exemplifying a processing method with respect to the request from the user in the SDS system 500 of the related art. In the example illustrated in FIG. 14, a process of a case where creation of a mirrored volume from the user is requested is illustrated.

The user inputs the request of the creation of the mirrored volume to the manager node 501-1 (see symbol S1). The manager node 501-1 creates a plurality (five in the example illustrated in FIG. 14) of commands (create Dev #2_1, create Dev #2_2, create Dev #3_1, create Dev #3_2, and create MirrorDev) (see symbol S2) in response to the request.

In the SDS system 500, the plurality of commands are executed in the agent nodes 501-2 and 501-3 as a series of commands for creating the mirrored volume. The manager node 501-1 requests the agent nodes 501-2 and 501-3 to process the created command (see symbol S3).

In the example illustrated in FIG. 14, the process of the commands “create Dev #2_1” and “create Dev #2_2” is requested to Agt #2 (see symbol S4) and the process of the commands “create Dev #3_1”, “create Dev #3_2”, and “create MirrorDev” is requested to Agt #3 (see symbol S5).

Each of the agent nodes 501-2 and 501-3 that have received the request executes the requested command (process) (see symbols S6 and S7), and responds to the manager node 501-1 that the command is completed. The manager node 501-1 confirms the response transmitted from each of the agent nodes 501-2 and 501-3 (see symbol S8).

For example, Japanese Laid-open Patent Publication No. 9-319633, Japanese Laid-open Patent Publication No. 2016-143248, and Japanese Laid-open Patent Publication No. 2016-133976 disclose related techniques.

### SUMMARY

According to an aspect of the embodiments, a storage system includes a plurality of server nodes including a first server node and a second server node paired with the first server node, and a manager node configured to manage the plurality of server nodes, wherein the first server node is configured to transmit a notification to the manager node in response to detecting that the second server node is down, and the notification indicates that the second server node is down, and wherein the manager node is configured to execute a first process related to a second process executed by the second server node in response to receiving the notification.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a hardware configuration of a storage system as an example of an embodiment;

FIG. 2 is a diagram exemplifying a logical device formed in the storage system as an example of the embodiment;

FIG. 3 is a diagram illustrating a functional configuration of the storage system as an example of the embodiment;

FIG. 4 is a diagram exemplifying job management information in the storage system as an example of the embodiment;

FIGS. 5A and 5B are diagrams exemplifying tasks in the storage system as an example of the embodiment;

FIG. 6 is a table exemplifying task management information in the storage system as an example of the embodiment;

FIG. 7 is a diagram for explaining transition of task progress status information in the storage system as an example of the embodiment;

FIG. 8 is a diagram exemplifying a process of creating a temporary file in an agent node of a SDS system of the related art;

FIG. 9 is a table exemplifying a non-volatile information management information in the storage system as an example of the embodiment;

FIG. 10 is a flowchart for explaining a process of a non-volatile information deletion unit at a start of each node in the storage system as an example of the embodiment;

FIG. 11 is a flowchart for explaining a process of a manager node in the storage system as an example of the embodiment;

FIGS. 12A and 12B are a flowchart for explaining a process when node down occurs in the storage system as an example of the embodiment;

FIG. 13 is a diagram schematically illustrating a configuration of a SDS system of the related art; and

FIG. 14 is a diagram exemplifying a processing method with respect to a request from a user in the SDS system of the related art.

### DESCRIPTION OF EMBODIMENTS

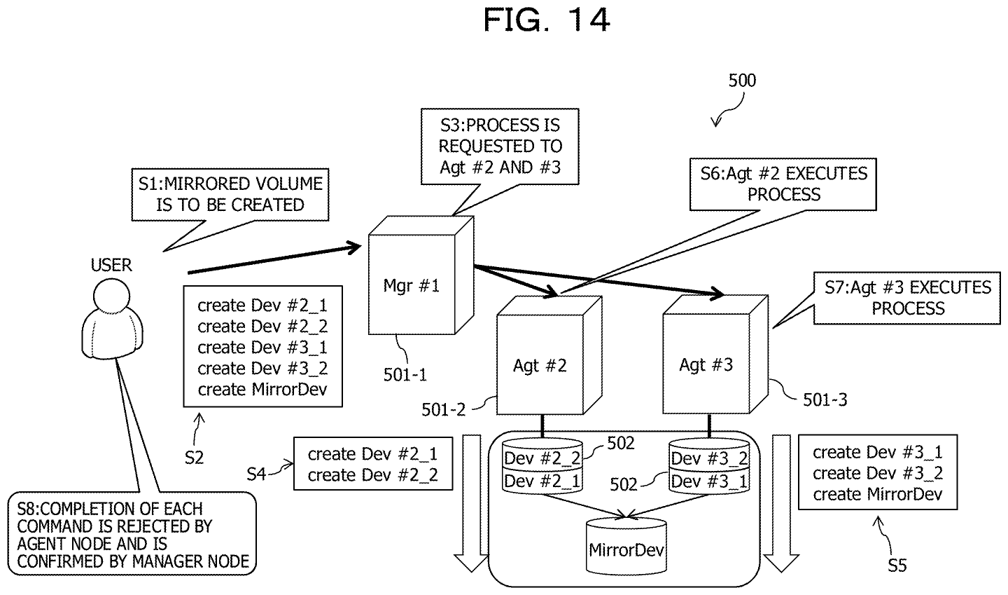

In the SDS system of the related art, one of the agent nodes 501 may be down while a plurality of agent nodes 501 execute processes. For example, in the example illustrated in FIG. 14, a case where the agent node 501-3 is down while executing the command “create MirrorDev” is considered.

The manager node 501-1 requests execution of the command “create MirrorDev” to the down agent node 501-3 repeatedly and continuously, and a timeout error is detected in a case where there is no response until a predetermined time has elapsed.

The manager node 501-1 may not respond even if another request is made from the user until the timeout is detected, thereby causing the user to wait.

As a result, the manager node 501-1 continues to useless retry (request to execute the command “create MirrorDev”) until it may establish a connection with the agent node 501-3.

In a cluster system, it is known to use cluster software including a function to detect down of the node, but cluster software may not know node down until it accesses management information, and it may not access the management information until the timeout is ended.

Hereinafter, embodiments of a storage system, a storage control device, and a storage control program will be described with reference to the drawings. However, the embodiments described below are merely examples, and there is no intention to exclude the application of various modifications and techniques that are not specified in the embodiments. For example, the embodiments may be variously modified and implemented without departing from the scope thereof. Each drawing is not intended to include only configuration elements illustrated in the drawings, but may include other functions and the like.

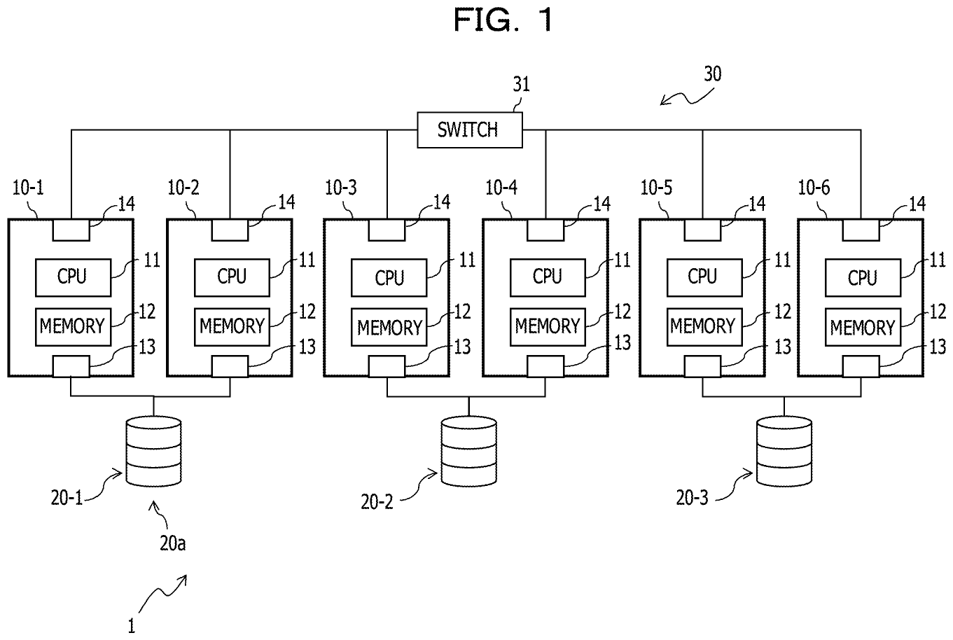

FIG. 1 is a diagram schematically illustrating a hardware configuration of a storage system 1 as an example of the embodiment.

The storage system 1 is a SDS system including a plurality (6 in the example illustrated in FIG. 1) of nodes 10-1 to 10-6 that control storage.

The nodes 10-1 to 10-6 are communicably connected to one another via a network 30.

The network 30 is, for example, a local area network (LAN) and in the example illustrated in FIG. 1, includes a network switch 31. The nodes 10-1 to 10-6 are respectively communicably connected to one another by being connected to the network switch 31 via a communication cable.

Hereinafter, as a symbol indicating a node, symbols 10-1 to 10-6 are used when it is preferable to specify one of a plurality of nodes, but symbol 10 is used to indicate any node.

In the storage system 1, one node 10 among the plurality of nodes 10 functions as a manager node, while other nodes 10 function as agent nodes. The manager node is an instruction node that manages the other nodes 10 (agent nodes) 10 and issues an instruction to the other nodes 10 in the storage system 1 of a multi-node configuration including the plurality of nodes 10. The agent node performs a process in accordance with an instruction issued from the instruction node.

Hereinafter, an example, in which the node 10-1 is the manager node and the nodes 10-2 to 10-6 are the agent nodes, will be described.

Hereinafter, the node 10-1 may be the manager node 10-1 and the node 10-1 may be indicated by Mgr #1. The nodes 10-2 to 10-6 may be the agent nodes 10-2 to 10-6 and the nodes 10-2 to 10-6 may be indicated by Agt #2 to #6.

When the manager node 10-1 fails, one of the agent nodes 10 takes over an operation of the manager node 10 and functions as a new manager node 10.

A just a bunch of disks (JBOD: physical device) 20-1 is connected to the node 10-1 and the node 10-2, and these are managed as one node block (storage casing). Similarly, JBOD 20-2 is connected to the node 10-3 and the node 10-4, and JBOD 20-3 is connected to the node 10-5 and the node 10-6, respectively.

Hereinafter, as a symbol indicating the JBOD, when it is preferable to specify one of a plurality of JBODs, symbols 20-1 to 20-3 are used, but when referring to any JBOD, symbol 20 is used.

The JBOD 20 is a storage device group in which a plurality of storage devices which are physical devices are logically connected, and is configured such that a sum of capacities of respective storage devices may be collectively used as a logical mass storage (logical device).

As the storage device constituting the JBOD 20, for example, a hard disk drive (HDD), a solid state drive (SSD), and a storage class memory (SCM) are used. The JBOD is realized by a well-known method, and the detailed description thereof will be omitted.

In the storage system 1, one node 10 accesses other nodes 10 via the network switch 31, so that the JBOD 20 connected to the other nodes 10 may be arbitrarily accessible.

Since two nodes 10 are connected to each JBOD 20, paths to each JBOD 20 are thereby made redundant.

In each node 10, a logical device using a storage area of the JBOD 20 may be formed.

Each node 10 may access the logical devices of the other nodes 10 via the network 30. Each node 10 may also access management information of the logical devices of the other nodes 10 via the network 30. Each node 10 may also access non-volatile information (store 20a; described later) of the other nodes 10 via the network 30.

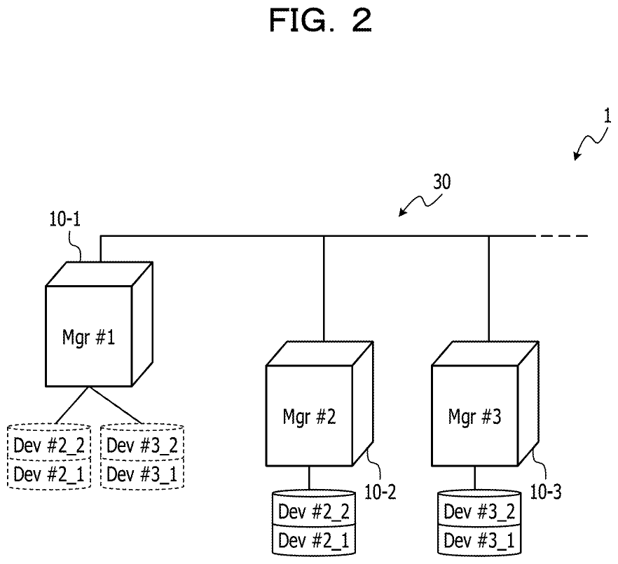

FIG. 2 is a diagram exemplifying the logical device formed in the storage system 1 as an example of the embodiment.

In the example illustrated in FIG. 2, the logical devices #2_1 and #2_2 are connected to the agent node 10-2 (Agt #2), and the logical devices #3_1 and #3_2 are connected to the agent node 10-3 (Agt #3).

The manager node 10-1 (Mgr #1) may access to the logical devices #2_1 and #2_2 of the agent node 10-2, and the logical devices #3_1 and #3_2 of the agent node 10-3 via the network 30. Therefore, the manager node 10-1 may refer to and change the logical devices #2_1 and #2_2 of the agent node 10-2, and the logical devices #3_1 and #3_2 of the agent node 10-3.

Similarly, the agent node 10-2 may access the manager node 10-1 (Mgr #1) and the logical devices #3_1 and #3_2 of the agent node 10-3 via the network 30. The agent node 10-3 may access the manager node 10-1 (Mgr #1) and the logical devices #2_1 and #2_2 of the agent node 10-2 via the network 30.

A stack configuration of the logical device of each node 10 is constituted and operated by a plurality of different commands.

Among a plurality of JBODs 20 included in the storage system 1, a part of the storage area of the JBOD 20 connected to the manager node 10-1 is used as the store 20a.

The store 20a is a non-volatile storage area (non-volatile storage device, storage unit), and is a persistent disk that stores and persists job management information 201, task management information 202, and non-volatile information management information 203 which are described later. The store 20a is an external storage device accessible from a plurality of other agent nodes 10 in addition to the manager node 10-1. Information stored in the store 20a is information for achieving persistence, that is, persistence information. Data is persisted by storing the data in the store 20a.

Each node 10 is, for example, a computer having a server function and includes a CPU 11, a memory 12, a disk interface (I/F) 13, and a network interface 14 as configuration elements. These configuration elements 11 to 14 are communicably constituted one another via a bus (not illustrated).

In the storage system 1, each agent node 10 forms high availability (HA) pair with another agent node 10.

In the HA pair, for example, in a case where one (partner) agent node 10 is stopped, another agent node 10 constituting the HA pair takes over the function of the partner and may continue the function to provide data.

Hereinafter, the node 10 constituting the HA pair may be referred to as the HA pair node 10 or simply the pair node 10. Each node 10 provides the storage area of the JBOD 20 as a storage resource.

The network I/F 14 is a communication interface communicably connected to the other nodes 10 via the network switch 31 and is, for example, a local area network (LAN) interface or a fibre channel (FC) interface.

The memory 12 is a storage memory including a read only memory (ROM) and a random access memory (RAM). In the ROM of the memory 12, a software program for control as an OS or the storage system, and data for the program are written. The software program on the memory 12 is appropriately read and executed by the CPU 11. The RAM of the memory 12 is used as a primary storage memory or a working memory. In the storage system 1, the memory 12 is not shared among the plurality of nodes 10.

For example, the job management information 201, the task management information 202, and the non-volatile information management information 203 which are described later may be stored in a predetermined area of the RAM of the memory 12 of the manager node 10-1.

For example, a manager node control program (control program) including a plurality of commands for causing the node 10 to function as the manager node 10-1 is stored in the JBOD 20 connected to each node 10. The manager node control program is read, for example, from the JBOD 20 and is stored (developed) in the RAM of the memory 12.

The node 10 may include an input device (not illustrated) such as a keyboard or a mouse, and an output device (not illustrated) such as a display or a printer.

The storage device may be provided in each node 10, and the manager node control program or an agent node control program may be stored in these storage devices.

The CPU 11 is a processing device (processor) incorporating a control unit (control circuit), an operation unit (operation circuit), a cache memory (register group), and the like, and performs various controls and operations. The CPU 11 implements various functions by executing the OS and programs stored in the memory 12.

In the node 10, the CPU 11 executes the manager node control program, so that the node 10 functions as the manager node 10.

The manager node 10 transmits an execution module of the agent node control program to another node 10 (agent node 10) included in the storage system 1 via the network 30. For example, the manager node 10 transmits the agent node control program to each agent node 10.

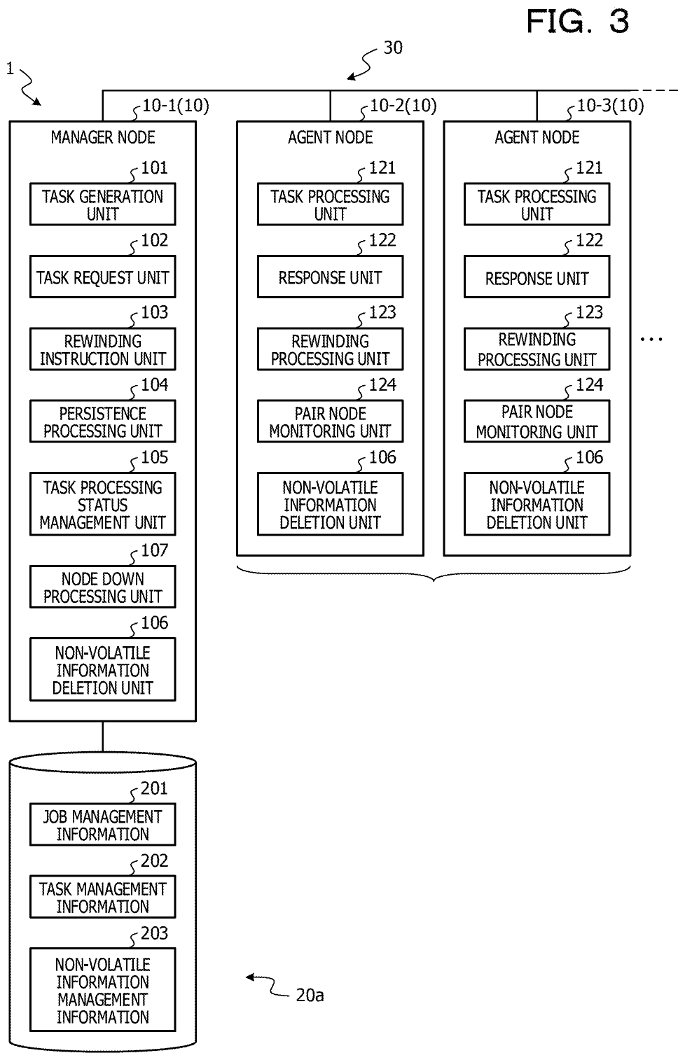

The agent node control program is a program including a plurality of commands for causing the CPU 11 of the agent node 10 to realize functions as a task processing unit 121, a response unit 122, a rewinding processing unit 123, a pair node monitoring unit 124, and a non-volatile information deletion unit 106 (see FIG. 3).

For example, when a task request unit 102 of the manager node 10, which is described later, transmits a task execution request to another node 10, the execution module of the agent node control program is added to the task execution request. Therefore, the agent node control program does not have to be installed on each agent node 10 and the cost required for management and operation may be reduced.

In the agent node 10, the CPU 11 executes the agent node control program, so that the node 10 functions as the agent node 10.

The manager node control program described above is provided, for example, in a form of being recorded on a computer readable recording medium such as a flexible disk, a CD (CD-ROM, CD-R, CD-RW, or the like), a DVD (DVD-ROM, DVD-RAM, DVD-R, DVD+R, DVD-RW, DVD+RW, HD DVD, or the like), a Blu-ray Disc, a magnetic disc, an optical disc, or a magneto-optical disc. The computer reads the program from the recording medium, and transfers the program to an internal storage device or an external storage device to use the program. The program may be recorded in, for example, a storage device (recording medium) such as a magnetic disk, an optical disk, or a magneto-optical disk, and may be provided from the storage device to the computer via a communication path.

FIG. 3 is a diagram illustrating a functional configuration of the storage system 1 as an example of the embodiment.

In the manager node 10-1, as illustrated in FIG. 3, the CPU 11 executes the manager node control program to realize functions as a task creation unit 101, a task request unit 102, a rewinding instruction unit 103, a persistence processing unit 104, a task processing status management unit 105, a node down processing unit 107, and the non-volatile information deletion unit 106.

In the storage system 1, a request for a logical device is input from the user to the manager node 10-1.

The task creation unit 101 creates a job having a plurality of tasks based on the request for the logical device input from the user.

In the storage system 1, a job is created for each request input from the user. For example, the manager node 10-1 receives a process by a job unit.

In the storage system 1, the plurality of tasks are executed for one job.

The task includes a series of the plurality of processes (commands) executed by the node 10. The command is a smallest unit of an operation to the logical device. The task is created for each node 10 and the commands included in one task, are processed by the same node 10. For example, the task is constituted by dividing the plurality of commands for processing one job into each processing subject node 10.

In the storage system 1, atomicity is guaranteed by the task unit. For example, in one task, an execution order of the commands is determined and a process of a next command is not started unless a process of a previous command is completed.

The task creation unit 101 creates the job management information 201 related to a job.

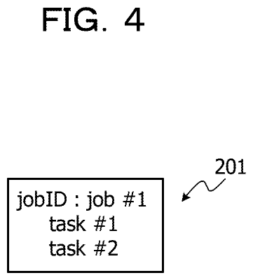

FIG. 4 is a diagram exemplifying the job management information 201 in the storage system 1 as an example of the embodiment.

The job management information 201 exemplified in FIG. 4 includes a job identifier (Job ID) for identifying a job, and a task identifier for identifying a task constituting the job.

The job management information 201 exemplified in FIG. 4 indicates a job of which the job identifier (Job ID) is “job #1”, and the job #1 includes two tasks (task #1 and task #2).

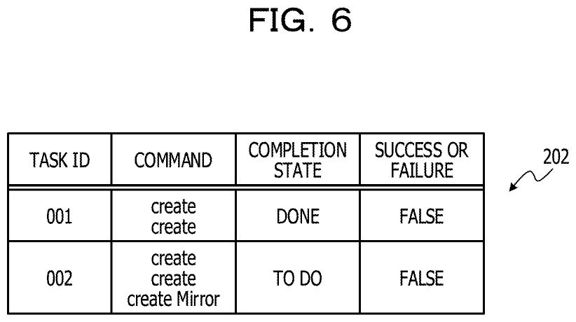

The task creation unit 101 creates the task management information 202 (described later with reference to FIG. 6) for each task to be created.

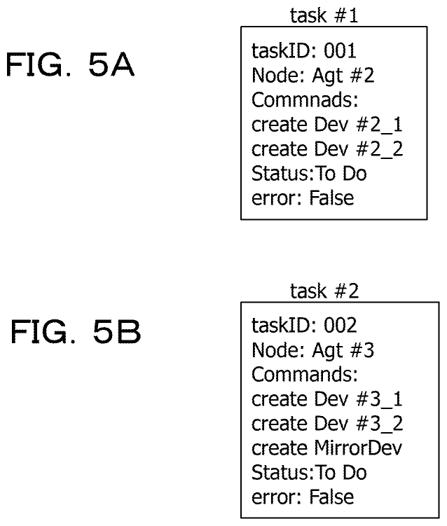

FIGS. 5A and 5B are diagrams exemplifying tasks in the storage system 1 as an example of the embodiment in which FIG. 5A exemplifies the task #1 and FIG. 5B exemplifies the task #2, respectively.

As illustrated in FIGS. 5A and 5B, the task includes a plurality of commands.

For example, the task #1 exemplified in FIG. 5A includes the command “create Dev #2_1” and “create Dev #2_2”. For example, the task #1 constructs the Dev #2_1 and the Dev #2_2.

The task #2 exemplified in FIG. 5B includes three commands “create Dev #3_1”, “create Dev #3_2”, and “create MirrorDev”. For example, the task #2 constructs the Dev #3_1 and the Dev #3_2, and constructs the create MirrorDev.

In the task #1, the commands described above are executed in the order of the “create Dev #2_1” and the “create Dev #2_2”, and in the task #2, the commands described above are executed in the order of the “create Dev #3_1”, the “create Dev #3_2”, and the “create MirrorDev”. In the job, the atomicity is guaranteed by the task unit.

In FIGS. 5A and 5B, a task identifier (task ID) uniquely specifying a task, node identifying information (Node) for identifying the node 10 that is an execution subject of the command included in the task, and task progress status information (Status) indicating a progress status of the task are illustrated. In FIGS. 5A and 5B, success or failure information (error) indicating success or failure is also illustrated.

These pieces of information are recorded in the task management information 202 and managed.

FIG. 6 is a table exemplifying the task management information 202 in the storage system 1 as an example of the embodiment.

The task management information 202 exemplified in FIG. 6 corresponds to the task #1 and the task #2 illustrated in FIGS. 5A and 5B.

The task management information 202 is information related to a task and the task management information 202 exemplified in FIG. 6 is constituted by associating a command, a completion state, and the success or failure (error) with task IDs.

The task ID is the task identifier (task ID) uniquely specifying the task. In the example illustrated in FIG. 6, a task ID “001” indicates the task #1 illustrated in FIG. 5A and a task ID “002” indicates the task #2 illustrated in FIG. 5B.

For the commands, commands included in the task are listed. In the task management information 202 illustrated in FIG. 6, only a command body is illustrated and arguments and options are omitted.

In a case where an instruction to execute a rewinding process to the agent node 10, of which the execution of the task is failed by the rewinding processing unit 123 (node down processing unit 107) described later, is issued, “Rollback” indicating an effect that the rewinding process is instructed is set in a column of the command corresponding to the task.

The completion state is a task progress status information (Status) indicating a progress status of the task. As the task progress status information, for example, one of “To Do” indicating that it is in an unexecuted state and “Done” indicating that the process is completed is set.

For example, in a case where a completion notification of the task or a completion notification (described later) of the rewinding process is received from the agent node 10, the task progress status information of the task management information 202 is rewritten from “To Do” to “Done” by the task processing status management unit 105 which is described later.

For example, in a case where a rewinding instruction is transmitted from the rewinding instruction unit 103 which is described later to the agent node 10, the task progress status information of the task management information 202 is rewritten from “Done” to “To do” by the task processing status management unit 105.

Hereinafter, the completion state (task progress status information) in the task management information 202 may be referred to as a status.

In the task management information 202 exemplified in FIG. 6, the task #1 of the task ID “001” includes two commands “create”. Since the completion state (task progress status information) is “Done”, it may be seen that the task #1 was already completed.

On the other hand, in the task management information 202 exemplified in FIG. 6, the task #2 of the task ID “002” executes two commands “create” and then executes “create MirrorDev”. Since the task progress status information is “To Do”, it may be seen that the task #2 is in a state of not being executed (not executed) by the agent node 10-3.

The success or failure (error) is information indicating whether a failure occurs during execution of the command included in the task. For example, in a case where a failure of the command execution occurs in one command included in the task, “True” which means that the failure occurs is set in the success or failure (error) by the task processing status management unit 105 which is described later. In a case where the failure of the command execution does not occur also in one commands included in the task, “False” which means an effect that the failure does not occur is set in the success or failure (error).

The task creation unit 101 may specify a plurality of agent nodes 10 executing the task in the plurality of agent nodes 10 included in the storage system 1, and create respective tasks with respect to the plurality of specified agent nodes 10. The agent node 10 that executes the task may be specified by using various methods such as preferentially selecting the agent node 10 having a low load among the plurality of agent nodes 10, or the like by using various methods.

The task management information 202 created by the task creation unit 101 is stored in a predetermined area of the memory 12. The task management information 202 stored in the memory 12 is persisted by being stored in the store 20a by the persistence processing unit 104 which is described later.

The task management information 202 includes node identifying information (Node) for identifying the node 10 executing the command included in the task.

The task request unit 102 transmits the task created by the task creation unit 101 to the agent node 10 of the processing subject agent node 10 of the task, and requests the execution thereof.

For example, the task request unit 102 refers to the task management information 202, extracts a task of which the task progress status is “To Do”, and transmits the task execution request to the agent node 10 specified by the node identifying information of the task management information 202, thereby requesting the execution of the task.

An execution module of a program (control program for the agent node) for realizing the functions as the task processing unit 121, the response unit 122, the rewinding processing unit 123, the pair node monitoring unit 124, and the non-volatile information deletion unit 106 to the CPU 11 of the agent node 10 is added to the task execution request transmitted to each agent node 10 by the task request unit 102. For example, the task request unit 102 transmits the agent node control program to each agent node 10.

In a case where the agent node 10 requesting the task is down, the task request unit 102 causes another agent node 10 selected by the node down processing unit 107 to request the execution (re-execution) of the task executed by the node 10 which is gone-down.

In a case where the rewinding instruction unit 103 receives, for example, a notification (failure notification) of an effect that the execution of the task is failed from the agent node 10, the rewinding instruction unit 103 causes the agent node 10 executing another task included in the same jab as the task to execute a process (rewinding process, rollback process) of returning to the state before execution of the task.

For example, in a case where a failure of the task #2 is notified from the Agt #3 with regard to the task #1 and the task #2 exemplified in FIGS. 5A and 5B, the rewinding instruction unit 103 instructs the Agt #2 that is the execution subject of the task #1 included in the same job #1 as the task #2 to execute the rewinding process to return to the state before the task #1 is executed.

The rewinding instruction unit 103 transmits the notification (rewinding instruction, rollback instruction) of instructing the execution of the rewinding process to the agent node 10.

The rewinding process means that the process returns to the state before the task is executed in the agent node 10 which has executed the task.

Therefore, in order to realize the rewinding process, in the task including the plurality of commands, it is desirable that each command is a reversible command.

For example, in a command (generation system command) for generating something, such as a command for creating a volume, it may return to the state before the command is executed by deleting a product (for example, volume) generated by executing the command. As described above, the command that may cause the system to return to the state before the execution of the command only by deleting the product obtained by executing the command is called as the reversible command.

For example, a command (command of an information changing system) for changing information such as name or attribute information may also be returned to the state before execution of the command by resetting (rewriting) to the information before changing. Therefore, also the command of the information changing system corresponds to the reversible command.

In the reversible command, the process may return to the state before the execution of the command by performing a process (for example, deletion or rewriting) of deleting the product obtained by the execution of the command.

In the storage system 1, the rewinding processing unit 123 deletes the product or resets the information of the reversible command to realize the rewinding to return to the state before the execution of the command.

On the other hand, for these reversible commands, for example, a command (command of a deletion system) for deleting a volume or the like is not generated even if the command is executed, and in a case where data of the memory 12 or the like is lost, there is no proof that it may be returned to an original state. Therefore, it is difficult to return to the state before the execution of the command. A command that is difficult to return to the state before the execution of the command, such as the command of the deletion system, is called an irreversible command.

The irreversible command may not be returned to the state before the execution of the command by performing the process (for example, deletion or rewriting) of deleting the product obtained by executing the command after the execution.

The rewinding instruction unit 103 instructs the agent node 10 executing the task constituted by the reversible commands to execute the rewinding process.

In a case where a function stop (node down) occurs in any of the agent nodes 10, the rewinding instruction unit 103 causes the agent node 10 executing another task included in the same job as the task executed in the agent node 10 where the node is down to execute the rewinding process. Hereinafter, the agent node 10 where the node is down may be referred to as a down node 10.

The rewinding instruction unit 103 performs the execution of the rewinding process due to the occurrence of such node down in response to the instruction from the node down processing unit 107.

The persistence processing unit 104 performs a process of storing information related to the task in the store 20a. For example, when the manager node 10-1 receives a job from the user, the persistence processing unit 104 reads the job management information 201 and the task management information 202 related to the job from the memory 12, and stores those in the store 20a. The persistence processing unit 104 may perform control to store the non-volatile information management information 203 in the store 20a.

The persistence processing unit 104 stores a state (for example, success or failure) of a process interaction with the agent node 10 related to the task in the store 20a. Therefore, when the manager node 10 crashes, a new manager node 10 may take over a process by referring to the store 20a.

For example, the persistence processing unit 104 stores a response (success or failure) for reporting an execution result of the task, which is transmitted from the agent node 10, in the store 20a in association with the task identifier of the task.

The persistence processing unit 104 stores information related to the rewinding instruction transmitted to the agent node 10, in the store 20a in association with the task identifier of the task of which a process is canceled by the rewinding instruction.

The persistence processing unit 104 stores information indicating a content (for example, whether the execution of the task has succeeded or failed) of the response to the rewinding instruction, which is transmitted from the agent node 10, in the store 20a in association with the task identifier of the task.

When the execution of all the tasks configuring a job is ended in the agent node 10, it is desirable that the persistence processing unit 104 deletes the job management information 201 and the task management information 202 related to the job from the store 20a.

The task processing status management unit 105 manages the task progress status in each agent node 10. The task processing status management unit 105 updates the task progress status information of the task management information 202 based on a process completion notification of the task transmitted from the agent node 10.

Information configuring the task management information 202 is developed (stored) in the memory 12 of the manager node 10-1, and the task processing status management unit 105 updates the task management information 202, or the like on the memory 12.

When a pair node down notification is performed from any agent node 10, the task processing status management unit 105 treats the task requested to the down node 10 as NG, and updates the progress status information to NG.

In a case where the rewinding instruction unit 103 performs the rewinding instruction to the agent node 10, the task processing status management unit 105 updates the task progress status information of the task management information 202 from the completion state (Done) to an incompletion state (To Do) according to the instruction.

The configuration data of the task management information 202 on the memory 12 is stored in the store 20a by the persistence processing unit 104, and is persisted.

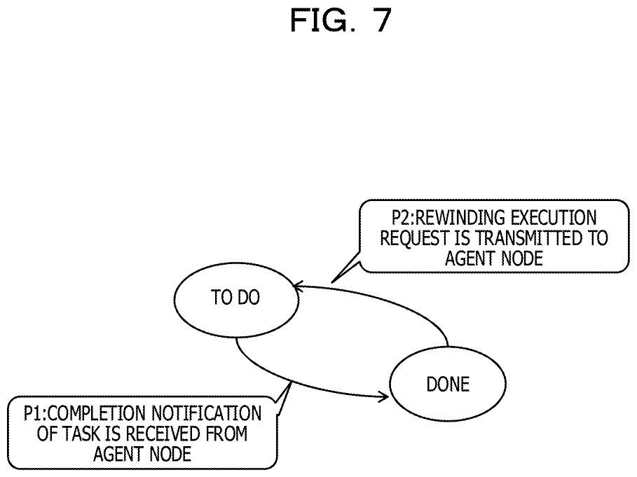

FIG. 7 is a diagram for explaining transition of the task progress status information in the storage system 1 as an example of the embodiment.

For example, in a case where the completion notification of the task or the completion notification (described later) of the rewinding process is received from the agent node 10, the task processing status management unit 105 rewrites the task progress status information of the task management information 202 from “To Do” to “Done” (see symbol P1 in FIG. 7).

For example, in a case where the rewinding instruction to the agent node 10 is transmitted from the rewinding instruction unit 103, the task processing status management unit 105 rewrites the task progress status information of the task management information 202 from “Done” to “To Do” (see symbol P2 in FIG. 7).

In a case where one of the agent nodes 10 is in the node down state, the node down processing unit 107 performs a predetermined process for the node down.

For example, the node down processing unit 107 causes the rewinding instruction unit 103 to execute the rewinding process to the agent node 10 executing another task included in the same job as the task executed in the down node 10.

The node down processing unit 107 detects (receives) an exception process (pair node down information) notifying that the HA pair node 10 is down from one of agent nodes 10.

When the pair node down notification is detected, the node down processing unit 107 determines that the task being executed in the down node 10 fails. The node down processing unit 107 selects an agent node 10 different from the down node 10, and causes the selected agent node 10 to execute (re-execute) the task executed in the down node 10 via the task request unit 102.

In the manager node 10-1, the pair node down notification is received by the network interface 14 via the network 30. Therefore, the network interface 14 corresponds to a receiving unit that receives the pair node down notification.

When the storage system 1 is started, the non-volatile information deletion unit 106 deletes the non-volatile information such as an unnecessary temporary file stored in the node 10 (hereinafter, may be referred to as a function node 10) of which the function is performed.

In the node of the storage system, a temporary file may be created and used internally for a purpose of configuration management or the like.

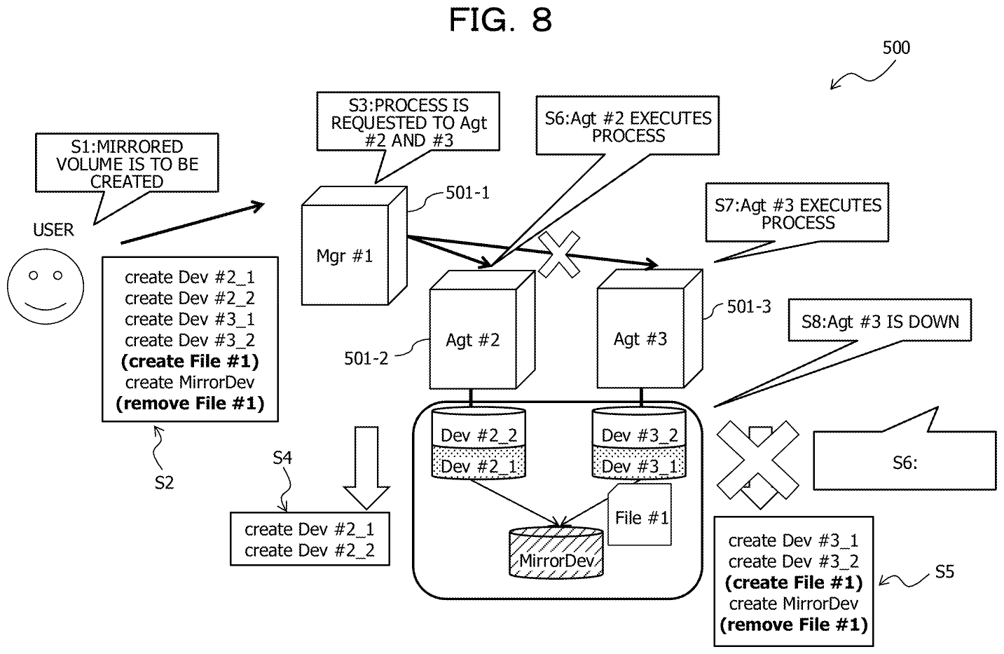

FIG. 8 is a diagram exemplifying a process of creating a temporary file in an agent node 501 of a storage system (SDS system) 500 of the related art.

The user inputs a request (job) for the logical device to the manager node 501-1 (see symbol S1).

In the example illustrated in FIG. 8, a process in a case where a creation of a mirrored volume is requested from the user is illustrated.

The manager node 501-1 creates a plurality (7 in the example illustrated in FIG. 8) of commands (create Dev #2_1, create Dev #2_2, create Dev #3_1, create Dev #3_2, create File #1, create MirrorDev, and remove File #1) according to the request (see symbol S2). The create File #1 is a command for creating the temporary file “File #1” and the remove File #1 is a command for deleting the temporary file “File #1”.

Such a temporary file additionally requires an execution result (for example, information such as address information, data size, or file name) of another command, for example, to calculate a size of a device, and is used in a case where it is desired to reuse the result in another process.

The manager node 501-1 requests the agent nodes 501-2 and 501-3 to process the created command (see symbol S3).

In the example illustrated in FIG. 8, the process of the commands “create Dev #2_1” and “create Dev #2_2” is requested to the Agt #2 (see symbol S4) and the process of the commands “create Dev #3_1”, “create Dev #3_2”, create File #1, “create MirrorDev”, and “remove File #1” is requested to the Agt #3 (see symbol S5).

Each of the agent nodes 501-2 and 501-3 received the request executes the commands (processes) which are respectively requested (see symbols S6 and S7).

In a case where the agent node 501-3 is down during the execution of the command create MirrorDev, that is, during the construction of MirrorDev (see symbol S8), since the command remove File#1 is not executed, the temporary file File #1 created by the agent node 501-3 remains.

Thereafter, the down agent node 501-3 is restarted, or information indicating that the temporary file File #1 is created, and information indicating that the MirrorDev is constructed do not remain. Therefore, the temporary file File #1 is not deleted. If such unnecessary temporary files (non-volatile file, non-volatile information, and unnecessary file) continue to be left, thereby causing area exhaustion of the storage device, or the like.

In the storage system 1, the non-volatile information deletion unit 106 refers to the non-volatile information management information 203 to delete such temporary files.

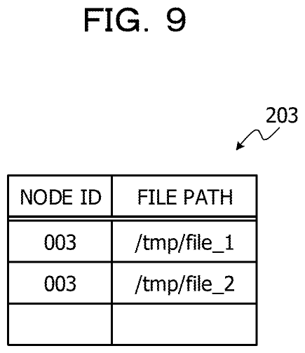

FIG. 9 is a table exemplifying the non-volatile information management information 203 in the storage system 1 as an example of the embodiment.

The non-volatile information management information 203 illustrated in FIG. 9 causes a file path indicating a storage position of the non-volatile information to be in association with the node ID that is the identifying information specifying the node 10.

In each node 10, when creating the temporary file, the task processing unit 121 described later records the storage position (file path) of the temporary file in the non-volatile information management information 203 in association with the node ID of the function node 10.

The non-volatile information management information 203 is stored in the store 20a of the manager node 10-1 and the non-volatile information deletion unit 106 of each node refers to the non-volatile information management information 203, so that the storage position of the non-volatile information in the function node 10 may be obtained.

In the non-volatile information management information 203, the storage position of a plurality of non-volatile files may be associated with one node ID.

When the function node 10 is started, the non-volatile information deletion unit 106 accesses the non-volatile information management information 203 of the store 20a, acquires the storage position of the non-volatile information of the function node 10, and deletes the non-volatile information (unnecessary file).

In the agent nodes 10-2 to 10-6, the CPU 11 executes the agent node control program (execution module), so that as illustrated in FIG. 3, the functions as the task processing unit 121, the response unit 122, the rewinding processing unit 123, the pair node monitoring unit 124, and the non-volatile information deletion unit 106 are realized.

The task processing unit 121 executes the task requested to be executed from the task request unit 102 of the manager node 10-1. For example, the task request unit 102 executes the plurality of commands included in the task requested to be executed according to a processing order.

In a case of creating the temporary file, the task processing unit 121 records the storage position (file path) of the temporary file in the non-volatile information management information 203 in association with the node ID of the function node 10.

The rewinding processing unit 123 performs the rewinding process to return the state of the function node 10 to the state before the task is executed by the task processing unit 121.

For example, in a case where the rewinding instruction for instructing the execution of the rewinding process is received from the rewinding instruction unit 103 of the manager node 10-1, the rewinding processing unit 123 performs the rewinding process.

The rewinding processing unit 123 performs the rewinding process to return the process (execution result) executed by the reversible command to the state before the execution.

For example, for the command of the generation system such as the volume creation, it returns to the state before the command is executed by deleting the product (for example, volume) generated by executing the command. For the command of the information changing system for changing information such as the name or attribute information, it returns to the state before the command is executed by resetting the information before the change.

When executing the task by the task processing unit 121, in a case where the task processing unit 121 fails in execution of any command included in the task, the rewinding processing unit 123 may perform the rewinding process.

For example, in a case where the rewinding processing unit 123 fails in the execution of any command in the plurality of commands included in the task, the rewinding processing unit 123 cancels the process of all the commands executed before the command that fails in the execution in the task. For example, in a case where the command executed before the command failed in execution is a creation of the device, the rewinding processing unit 123 deletes the created device, thereby returning to the state before the command is executed.

Even for a command other than the generation system or the information changing system, for example, in a case where it may easily returned to the state before the command is executed by executing a specified command such as undo or cancel, the rewinding process may be executed in such a command or may be executed with various modifications.

For example, the task (task #2) exemplified in FIG. 5B is to be executed by the agent node 10-3 (Agt #3), and three commands “create Dev #3_1”, “create Dev #3_2”, and “create MirrorDev” are executed in this order.

In the agent node 10-3 (Agt #3), an example in which, for example, the execution of the command “create Dev #3_2” fails in the process, in which the task processing unit 121 executes the task (task #2), is considered. In such a case, in the agent node 10-3 (Agt #3), the rewinding processing unit 123 deletes the process of all the commands “create Dev #3_1” before the command “create Dev #3_2”. Therefore, the agent node 10-3 (Agt #3) may be returned to the state before the task (task #2) is executed.

For the process executed by the irreversible command, the rewinding processing unit 123 ignores the rewinding process without performing the rewinding process even if the rewinding instruction is received from the rewinding instruction unit 103 of the manager node 10-1.

In a case where the process of the task is completed by the task processing unit 121, the response unit 122 notifies the manager node 10-1 of the process completion of the task.

The response unit 122 transmits the completion notification at timing when the process of all the commands included in the task is executed by the task processing unit 121 and the process of the task unit is completed. For example, the response unit 122 does not transmit the completion notification of the process of the command unit but transmits the completion notification of the process of the task unit.

When the execution of the task is performed by the task processing unit 121, in a case where the task processing unit 121 fails in the execution of any command included in the task, the response unit 122 notifies the manager node 10-1 of the failure of the execution of the task. In this case, it is desirable that the response unit 122 notifies the manager node 10-1 of the failure of the execution of the task after the rewinding process is executed by the rewinding processing unit 123.

Therefore, the response unit 122 functions as a first response unit that responds a first notification indicating that the execution of all the series of the plurality of processes (commands) included in the task is normally completed.

In a case where the task processing unit 121 fails in the execution of the irreversible command, the response unit 122 suppresses the notification of the command failure to the manager node 10-1. Therefore, the notification of the execution failure of the command to the manager node 10-1 is not performed and, as a result, in the manager node 10-1, the command execution is treated as success.

For example, in a case where the execution of the irreversible command fails, the response unit 122 causes the manager node 10-1 to assume that the command execution has succeeded. As described above, the irreversible command is, for example, deletion of the volume.

The agent node 10 executes a next process without notifying the manager node 10 of the notification of the failure even if the process fails for the irreversible command. The response unit 122 responds to the manager that all the processes have succeeded. For the task including the command, even if the instruction of the rewinding process is received from the manager node 10, the instruction is ignored and the execution of the rewinding process is suppressed.

The process once started by the agent node 10 may be completed in either success or failure state, even if an abnormal state is obtained without involving the manager node 10.

Therefore, in the manager node 10, waiting due to an error process is unnecessary and a load of the manager node 10 may be reduced. Since the waiting or the like due to the error process is unnecessary, the manager node 10 may execute another process and may realize an efficient process.

Hereinafter, even if the command process fails in the agent node 10, the response unit 122 suppresses that the notification of the failure is notified to the manager node 10, and an assumption that the command execution has succeeded may be called a corrective commit.

The failure of the command process in the agent node 10 is separately recorded in a system log or the like. Therefore, there is no problem due to the response unit 122 of the agent node 10 not notifying the manager node 10 of the notification of the failure.

In the storage system 1, in a case where the manager node 10 is down while the agent node 10 executes a process, the following process is performed.

For example, when the manager node 10-1 crashes, one of the agent nodes 10 becomes a manager node 10 (new manager node 10) which is new.

In the manager node 10, as described above, the persistence processing unit 104 stores a state of the process interaction with the agent node 10 related to the task, in the store 20a.

The new manager node 10 may take over the process of the down manager node 10 by referring to the store 20a.

Even in a case where the rewinding process is completed by the rewinding instruction unit 103, the response unit 122 responds to the manager node 10-1 of the completion notification.

Therefore, the response unit 122 functions as a second response unit that responds to the second notification when the execution of the rewinding process is normally completed.

The pair node monitoring unit 124 monitors the pair node 10 with respect to the function node 10. When the node down of the pair node 10 is detected, the pair node monitoring unit 124 notifies the manager node 10 of the pair node down. It is desirable that the pair node down notification is performed as an exception process. The pair node down notification may include, for example, the node ID of the node 10 which is node down and a function indicating the occurrence of the node down. Hereinafter, the pair node down notification performed as the exception process may be referred to as a node down exception.

The detection of the node down of the pair node may be realized by using various well known methods, and the description of details thereof will be omitted.

When the storage system 1 is started, the non-volatile information deletion unit 106 deletes the non-volatile information such as the unnecessary temporary file stored in the node 10 (hereinafter, may be referred to as the function node 10) of which the function is provided.

The function as the non-volatile information deletion unit 106 in the agent node 10 is similar to that of the non-volatile information deletion unit 106 in the manager node 10, so that the description of details thereof will be omitted.

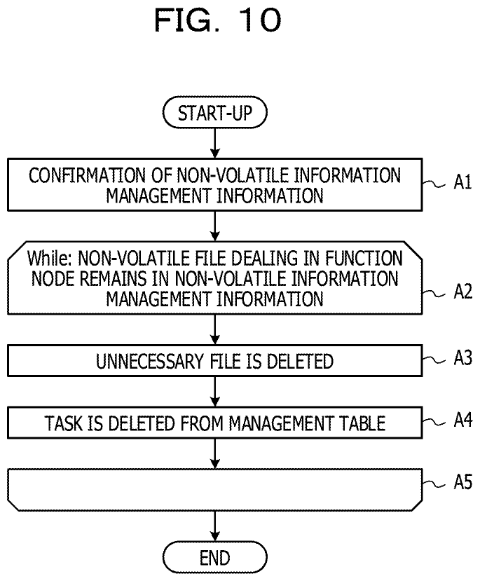

First, in the storage system 1 as an example of the embodiment configured as described above, when each node 10 is started, the process of the non-volatile information deletion unit 106 will be described with reference to a flowchart (steps A1 to A5) illustrated in FIG. 10. The following process is performed in each of the manager node 10 and the agent node 10.

For example, when the node 10 is powered on, in step A1, the non-volatile information deletion unit 106 confirms the non-volatile information management information 203 stored in the store 20a.

In step A2, a loop process repeatedly executing control up to step A5 is started with respect to all the non-volatile files in association with the node ID of the function node 10 in the non-volatile information management information 203.

In step A3, the non-volatile information deletion unit 106 deletes the unnecessary file indicated by the file path in association with the node ID of the function node 10 in the non-volatile information management information 203.

In step A4, the non-volatile information deletion unit 106 deletes the task which is not completed from the task management information 202.

Thereafter, the control proceeds to step A5. In step A5, a loop end process corresponding to step A2 is performed. When the process for all the non-volatile files in association with the node ID of the function node 10 is completed, the present flow ends.

When the node 10 is started, the non-volatile information deletion unit 106 performs the deletion of the unnecessary file. Therefore, it is ensured that the non-volatile file of which the storage position is indicated by the non-volatile information management information 203 is in an unused state. For example, an erroneous deletion of the file in use may be suppressed and the non-volatile file may be safely deleted.

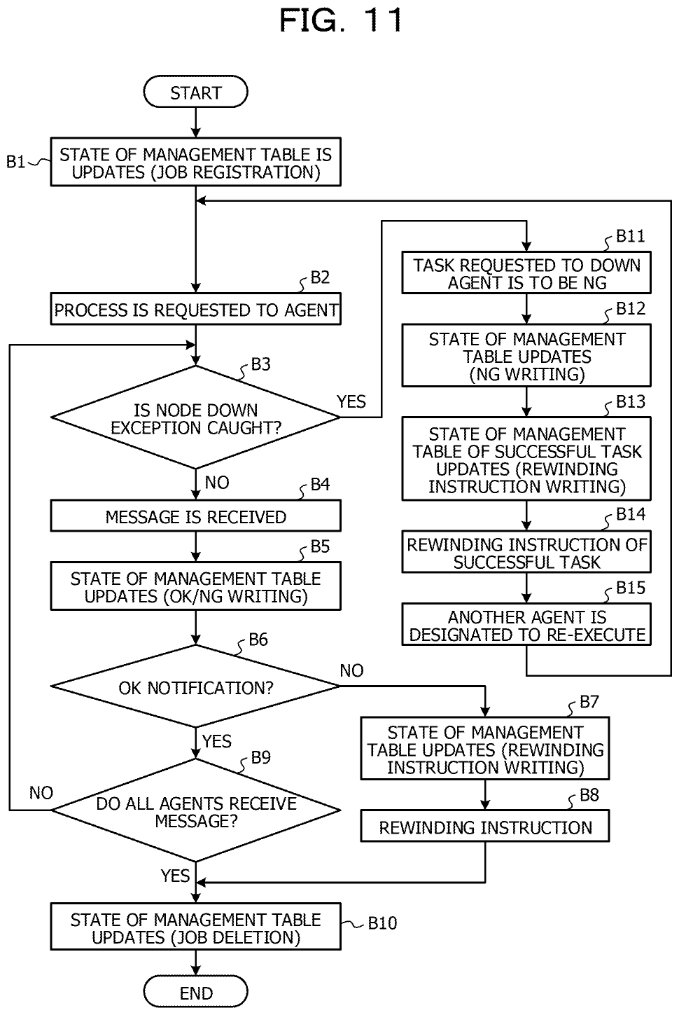

Next, the process of the manager node 10-1 in the storage system 1 as an example of the embodiment will be described according to a flowchart (steps B1 to B15) illustrated in FIG. 11.

In step B1, in the manager node 10-1, the task creation unit 101 creates a job and a plurality of tasks included in the job based on a request input from the user. The task processing unit 121 registers (job registration) information related to the created job in the job management information 201. The task creation unit 101 registers the information related to the created task in the task management information 202.

In step B2, the task request unit 102 requests the agent node 10 to process each of a plurality of created tasks. The task request unit 102 performs the process request by transmitting a message requesting the process together with the task, to the agent node 10.

In step B3, the node down processing unit 107 confirms whether the exception process of the pair node down notification from one of the agent nodes 10 is detected (caught).

In a case where the exception process of the node down is not caught (see NO route in step B3) and the procedure proceeds to step B4.

In step B4, the task processing status management unit 105 receives a response notification message (message) related to the task requesting the execution from the agent node 10 requesting the execution of the task. The response notification message from the agent node 10 includes a notification of an effect (OK) in which the process of the task is completed, or a notification of an effect (NG) in which the process of the task fails.

In step B5, the task processing status management unit 105 updates information (task progress status information) of the success or failure of the task management information 202 based on the received message. It is desirable that the updated task management information 202 is stored in the store 20a by the persistence processing unit 104 and is persisted.

In step B6, the task processing status management unit 105 confirms whether the response notification message received from the agent node 10 is the notification of the effect (OK) in which the process of the task is completed.

As a result of the confirmation, in a case where the received response notification message does not notify the process completion (OK) (see NO route of step B6), the procedure proceeds to step B7.

In step B7, the task processing status management unit 105 updates the task management information 202. For example, the task processing status management unit 105 registers a value (False) indicating the failure in the information (task progress status information) of the success or failure of the task management information 202.

The task processing status management unit 105 writes information of an effect instructing the rewinding process, in the task management information 202. It is desirable that the updated task management information 202 is stored in the store 20a by the persistence processing unit 104 and is persisted.

In step B8, the rewinding instruction unit 103 notifies the agent node 10 of the rewinding instruction.

The order of these steps B7 and B8 is not limited to the example. For example, the order of the process of step B7 and the process of step B8 may be switched, or the process of step B7 and the process of step B8 may be performed in parallel. Thereafter, the procedure proceeds to step B10.

As a result of the confirmation in step B6, in a case where the received response notification message notifies the process completion (OK) (see YES route of step B6), the procedure proceeds to step B9.

In step B9, the task processing status management unit 105 confirms whether a response completion message is received from all the agent nodes 10 requesting the execution of the task in step B2.

As a result of the confirmation, in a case where there is the agent node 10 which does not receive the response completion message (see NO route of step B9), the procedure returns to step B3. On the other hand, in a case where the response completion message is received from all the agent nodes 10 (see YES route of step B9), the procedure proceeds to step B10.

In step B10, the persistence processing unit 104 deletes the job management information 201 and the task management information 202 related to the job #1 in which the process from the store 20a is completed. Thereafter, the process is ended.

As a result of confirmation in step B3, in a case where the exception process of the node down is caught (see YES route of step B3), the procedure proceeds to step B11.

In step B11, the task processing status management unit 105 determines that the task requested to the down node 10 is NG, and in step B12, writes the task management information 202 to update the task progress status information to NG.

The task processing status management unit 105 writes the task management information 202 to update the task progress status information to a state indicating the rewinding instruction for a task which is related to the task requested to the down node 10 and is completed (process succeeds) in step B13.

For example, the task processing status management unit 105 changes the completion state (progress status information) to “To Do” and changes the completion state to an issuance state of the command “Rollback” with respect to the task in the task management information 202.

Thereafter, in step B14, the rewinding instruction unit 103 issues the rewinding instruction to the agent node 10 that has executed a task related to the task requested to the down node 10.

In step B15, the task request unit 102 selects another agent node 10 which is not down, designates the selected agent node 10, and executes (re-executes) the task requested to the down node 10. Thereafter, the procedure returns to step B2.

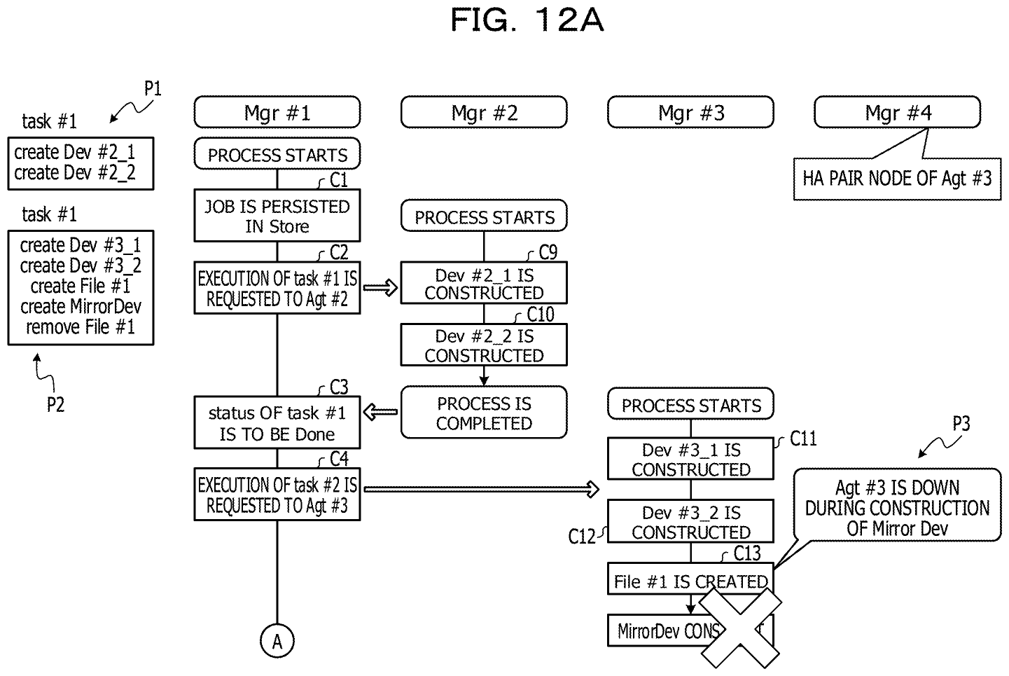

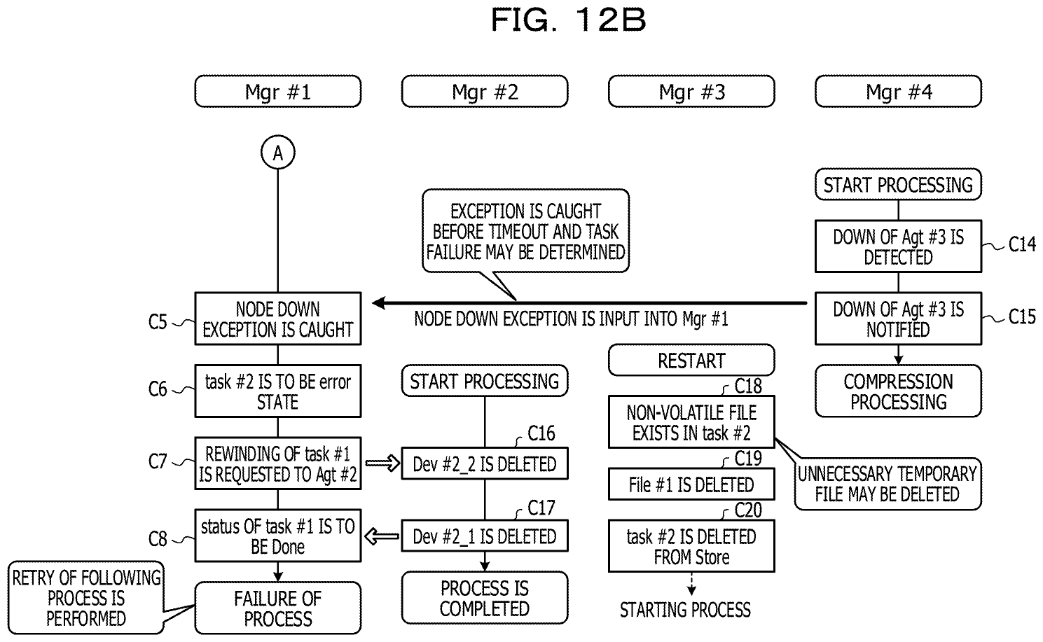

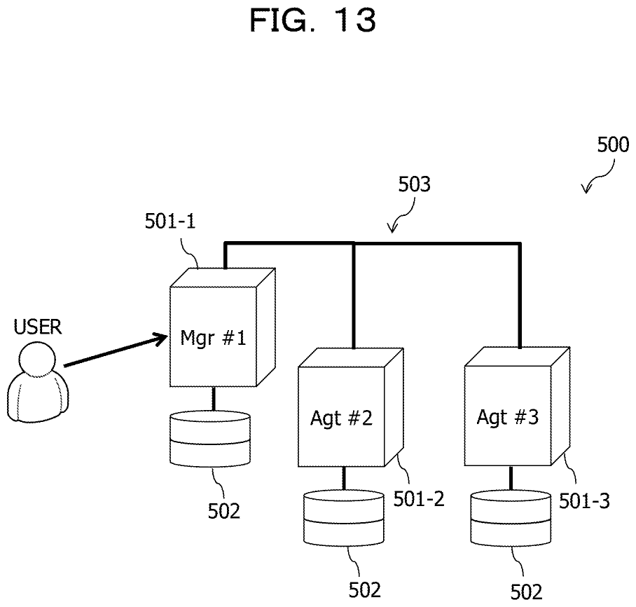

Next, a process when the node down occurs in the storage system 1 as an example of the embodiment will be described according to a flowchart (steps C1 to C20) illustrated in FIGS. 12A and 12B.

Also in FIGS. 12A and 12B, an example in which the mirrored volume is created in response to the request from the user is illustrated, and a case where the agent node 10-3 (Agt #3) is down in the middle of the execution of the task (task #2). The agent node 10-4 (Agt #4) and the agent node 10-3 (Agt #3) constitute the HA pair. For example, the agent node 10-4 (Agt #4) is the HA pair node 10 of the agent node 10-3 (Agt #3).

In the initial state of the task management information 202, “To Do” is set as the completion state of each task and “False” is set as the success or failure (error).

In the manager node 10-1 (Mgr #1), a creation process of the mirrored volume is started.

In step C1, in the manager node 10-1, the task creation unit 101 creates the job (job #1) including the task #1 and the task #2 (see symbols Q1 and Q2). The persistence processing unit 104 stores the information of the job and the task which are created in the store 20a and persists the information.

In step C2, the task request unit 102 of the manager node 10-1 requests the agent node 10-2 (Agt #2) to execute the task #1.

In the agent node 10-2 (Agt #2), the task processing unit 121 starts the process of the task #1 in response to the request. For example, in the agent node 10-2 (Agt #2), a plurality of commands included in the task #1 are sequentially executed.

The task processing unit 121 constructs Dev #2_1 and Dev #2_2 as the task #1 (steps C9 and C10), and the process is ended. When the process of the task #1 is completed by the task processing unit 121, the response unit 122 transmits the completion notification of the process of the task #1 to the manager node 10-1.

In step C3, the task processing status management unit 105 of the manager node 10-1, which has received the process completion notification of the task #1 from the response unit 122 of the agent node 10-2 (Agt #2), sets “Done” to the completion state (status) of the task #1 in the task management information 202.

The task processing status management unit 105 of the manager node 10-1 sets “To Do” to the completion state of the task #2 in the task management information 202. In step C4, the task request unit 102 of the manager node 10-1 requests the agent node 10-3 (Agt #3) to execute the task #2.

The task processing unit 121 starts the process of the task #2 in response to the request in the agent node 10-3 (Agt #3). For example, in the agent node 10-3 (Agt #3), the plurality of commands included in the task #2 are sequentially executed.

The task processing unit 121 constructs Dev #3_1 (step C11), and then constructs Dev #3_2 (step C12) as the task #2. The task processing unit 121 creates File #1 (step C13).

Thereafter, the task processing unit 121 starts the construction of the MirrorDev, but in the middle thereof, the agent node 10-3 (Agt #3) is down (see symbol P3).

In step C14, in the agent node 10-4 (Agt #4) that is the HA pair node 10 of the agent node 10-3 (Agt #3), the pair node monitoring unit 124 detects the down of the agent node 10-3 (Agt #3).

In step C15, the pair node monitoring unit 124 of the agent node 10-4 notifies the manager node 10-1 of the down of the agent node 10-3 (Agt #3). Thereafter, the process in the agent node 10-4 is ended.

In step C5, the manager node 10-1 catches the node down exception from the agent node 10-4 (Agt #4). As described above, the manager node 10-1 may determine the failure of the execution of the task by catching the node down exception from the agent node 10-4 before detecting the timeout error with respect to the agent node 10-3.

In step C6, the task processing status management unit 105 of the manager node 10-1 sets “True” in the success or failure (error) of the task #2 in the task management information 202 to set the task #2 in an error state.

In the manager node 10-1, the rewinding instruction unit 103 performs rewinding of a task other than the tasks determined to have failed by the occurrence of the node down. The rewinding instruction unit 103 specifies the task #1 created based on the same job as the task #2 requested to the agent node 10-3 (Agt #3) that is the down node 10. The rewinding instruction unit 103 sets the status of the task #1 in the task management information 202 to To Do, and sets the command to Rollback.

In step C7, the rewinding instruction unit 103 of the manager node 10-1 instructs the agent node 10-2 which has executed the task #1 to execute the rewinding process of the task #1. Therefore, the rewinding process in the agent node 10-2 is started.

In step C16, the rewinding processing unit 123 of the agent node 10-2 deletes Dev #2_2, and then deletes Dev #2_1 in step C17. As described above, it is desirable that when performing the rewinding process of the task, the rewinding processing unit 123 deletes the execution results of the plurality of commands included in the task in a reverse order of the execution order. Thereafter, the process in the agent node 10-2 is ended.

On the other hand, in the manager node 10-1, in step C8, the task processing status management unit 105 rewrites the status of the task #1 to Done in the task management information 202.

As described above, when the agent node 10-3 is down during the execution of the task, the requested job fails.

Thereafter, the node down processing unit 107 of the manager node 10-1 selects an agent node 10 different from the down node 10, and causes the selected agent node 10 to execute (re-execute, retry) the task being executed in the down node 10 via the task request unit 102.

When the retry of the task executed by the down node 10 is completed, the task processing status management unit 105 deletes the task related to the job #1 from the task management information 202. In the manager node 10-1, the persistence processing unit 104 deletes the information related to the job #1 from the store 20a. The manager node 10-1 notifies the user of the completion of the creation of the mirrored volume, and the process is ended.

The agent node 10-3 which is down is restarted. In step C18, the non-volatile information deletion unit 106 refers to the non-volatile information management information 203 of the store 20a to grasp that the non-volatile file exists in the function node 10 and acquire the storage position.

In step C19, the non-volatile information deletion unit 106 deletes the non-volatile file in the function node 10.

In the agent node 10-3, the task #2 is deleted from the store 20a (step C20), and then various processes for starting the device are performed.

As described above, in the storage system 1 as an example of the embodiment, in the agent node 10, when the pair node monitoring unit 124 detects that the HA pair node 10 is down, the exception process of the pair node down notification is performed with respect to the manager node 10.

In the node down processing unit 107 of the manager node 10, the failure of the task on the spot may be determined by receiving the pair node down notification from the agent node 10 during the execution of the task as the exception notification. For example, in the manager node 10, the failure of the task may be detected without waiting the detection of the timeout error. Therefore, the response time to the node down may be shortened and the cost for performing unnecessary retry may be reduced. The cost of unnecessary communication process while the node is down is reduced, and the switching process of the processes during execution may be speeded up. For example, in a case where the agent node 10 is down, it may be dealt with promptly and the response time and the processing cost when the agent node 10 is down may be reduced.

In the node 10 in which the node down occurs, when starting the node 10, the non-volatile information deletion unit 106 refers to the non-volatile information management information 203 and grasps the storage position of the non-volatile file to delete. Therefore, the unnecessary temporary file in the node 10 may be deleted. Therefore, the occurrence of disk exhaustion and data inconsistency may be suppressed, and the reliability may be improved.

When starting the node 10, the non-volatile information deletion unit 106 deletes the unnecessary file, so that it is ensured that the non-volatile file of which the storage position is indicated by the non-volatile information management information 203 is in the unused state. For example, the erroneous deletion of the file in use may be suppressed and the non-volatile file may be safely deleted.

The non-volatile information management information 203 is stored in the store 20a, so that the non-volatile information deletion unit 106 in each node 10 refers to the non-volatile information management information 203, and the non-volatile file in the function node 10 may easily be confirmed.

The disclosed technique is not limited to the embodiments described above, and various modifications may be made without departing from the spirit of the embodiments. Each of the configurations and processes of the embodiments may be selected as appropriate, or may be combined as appropriate.

For example, the number of the nodes 10 included in the storage system 1 is not limited to 6, but 5 or less, or 7 or more nodes 10 may be provided.

In the embodiments described above, the manager node 10-1 (task request unit 102) transmits the execution module of the agent node control program together with the task execution request to the agent nodes 10-2 to 10-6, but the configuration is not limited to the embodiments.

For example, the agent node control program for causing the node 10 to function as the agent node 10 is stored in the storage device such as the JBOD 20, and the node 10 reads and executes the agent node control program from the JBOD 20, thereby realizing each function as the agent node 10.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A storage system comprising:
a plurality of server nodes including a first server node and a second server node paired with the first server node; and
a manager node including a first memory and a first processor configured to manage the plurality of server nodes,
wherein the first server node includes a second memory and a second processor configured to transmit a notification to the manager node in response to detecting that the second server node is down, and the notification indicates that the second server node is down, and
wherein the first processor is configured to execute a first process related to a second process executed by the second server node in response to receiving the notification.

2. The storage system according to claim 1,
wherein the first process includes instructing a server node other than the second server node to return to a state before execution about one or more processes that has been executed successfully by the server node, and the one or more processes are related to the second process.

3. The storage system according to claim 1,
wherein the first process includes instructing a server node other than the second server nodes to execute the second process.

4. The storage system according to claim 1,
wherein the second server node includes a third memory and a third processor configured to, when restarting after the down, delete non-volatile information generated by executing the second process with reference to management information indicating a storage position of the non-volatile information.

5. The storage system according to claim 1,
wherein the notification is transmitted before the manager node detects the down of the second server node by timeout.

6. The storage system according to claim 1,
wherein the first server node and the second server node form a high availability pair.

7. A storage control method comprising:
transmitting, by a first server node, a notification to a manager node in response to detecting that a second server node is down, the second server node being paired with the first server node, the manager node being configured to manage a plurality of server nodes including the first server node and the second server node; and
executing, by the manager node, a first process related to a second process executed by the second server node in response to receiving the notification.

8. The storage control method to claim 7,
wherein the first process includes instructing a server node other than the second server node to return to a state before execution about one or more processes that has been executed successfully by the server node, and the one or more processes are related to the second process.

9. The storage control method according to claim 7,
wherein the first process includes causing a server node other than the second server node to execute the second process.

10. The storage control method according to claim 7, further comprising:
when the second server restarts after the down, deleting, by the second server node, non-volatile information generated by executing the second process with reference to management information indicating a storage position of the non-volatile information.

11. The storage control method according to claim 7,
wherein the notification is transmitted before the manager node detects the down of the second server node by timeout.

12. The storage control method according to claim 7, wherein the first server node and the second server node form a high availability pair.

13. A storage control device comprising:
a memory; and
a processor coupled to the memory and the processor configured to
receive notification transmitted by a first server node when the first server node detects that a second server node is down, the second server node being paired with the first server node, and
execute a first process related to a second process executed by the second server node in response to the received notification.
